(19) United States
(12) Patent Application Publication
(10) Pub. No.: US 2008/0082396 A1
(43) Pub. Date: Apr. 3, 2008

(54) Consumer Marketing System and Method

(76) Inventors: Joseph J. O'Connor, Bloomfield Hills, MI (US); Patrick Frenzel, Bloomfield Hills, MI (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 11/840,756

(22) Filed: Aug. 17, 2007

Related U.S. Application Data
(60) Provisional application No. 60/822,718, filed on Aug. 17, 2006.

(51) Int. Cl. G06Q 30/00; G06F 17/40; G06F 19/00

(52) U.S. Cl. 705/10; 705/14

(57) ABSTRACT

Consumer marketing systems and methods that utilize consumer data gathering techniques to allow merchants and businesses to more efficiently focus their marketing efforts towards those customers that are likely to buy their goods and/or services. The system provides: (1) increased customer usage and loyalty through unique, timely and relevant values from merchants or businesses that customers are not likely to find elsewhere; (2) quantifying the value of patronizing the merchant or business by demonstrating to customers that the overall savings exceeds the cost of any membership fees and/or the like; (3) incorporating an information based strategy that will enable management to better understand their own customer base in order to increase penetration with its own products and services and identify opportunities for new services; (4) attracting new customers and reduce defection among existing customers; (5) enhancing the value of the Internet-based program for merchants or businesses, allowing them to better target market to the merchant's or business' existing customers; and (6) increasing the number of overall merchant or business relationships and the number of merchants or businesses willing to pay for access and enhanced features.

### CROSS-REFERENCE TO RELATED APPLICATION

The instant application claims priority to U.S. Provisional Patent Application Ser. No. 60/822,718, filed Aug. 17, 2006, the entire specification of which is expressly incorporated herein by reference.

### FIELD OF THE INVENTION

The subject invention relates to consumer marketing systems and more specifically to consumer marketing systems and methods that utilize consumer data gathering techniques to allow merchants and businesses to more efficiently focus their marketing efforts towards those customers that are likely to buy their goods and/or services.

### BACKGROUND OF THE INVENTION

Over the past several years, the Internet has transformed consumer commerce by providing what seems like unlimited and dynamic choices for consumers. For example, approximately two thirds of households in the United States currently have Internet access. In 2004, consumers purchased $500 billion dollars of goods and services online. This number is projected to grow to $1.2 trillion by 2008. This ongoing transformation demands that businesses continue to adjust rapidly in order to remain competitive and thrive. However, many conventional online marketing techniques are too broadly applied in order to reach the greatest number of consumers (e.g., spam, popup ads, banner ads, and/or the like), and thus valuable marketing resources are squandered by marketing to individuals who do not have any, or very little, interest in the particular merchant's goods and/or services.

Therefore, it would be advantageous to provide new and improved consumer marketing systems and methods that overcome at least one of the aforementioned problems.

### SUMMARY OF THE INVENTION

The present invention provides consumer marketing systems and methods that utilize consumer data gathering techniques to allow merchants and businesses to more efficiently focus their marketing efforts towards those customers that are likely to at least consider buying their goods and/or services. Although traffic in the digital world continues to expand exponentially, the smarter merchants and businesses are focused not only on “reach” but also on “relevance.” In accordance with the present invention, an emphasis on relevance requires that companies adopt an information based strategy in order to develop an intimate knowledge of customer (both potential and existing) needs and preferences.

The present invention greatly enhances existing Internet-based programs by revamping the programs to be more attuned to consumer/customer/member and business behavior in the digital world. The primary objective of the present invention is to increase consumer/customer/member loyalty by offering enhanced member benefits. It should be noted that the terms “consumer,” “customer,” and “member” are being used interchangeably herein.

In accordance with a non-limiting example, some goals of the present invention are as follows: (1) increase customer usage and loyalty through unique, timely and relevant values from merchants or businesses that customers are not likely to find elsewhere; (2) quantify the value of patronizing the merchant or business by demonstrating to customers that the overall savings exceeds the cost of any membership fees and/or the like; (3) incorporate an information based strategy that will enable management to better understand their own customer base in order to increase penetration with its own products and services and identify opportunities for new services; (4) attract new customers and reduce defection among existing customers; (5) enhance the value of the Internet-based program for merchants or businesses, allowing them to better target market to the merchants' or businesses' existing customers; and (6) increase the number of overall merchant or business relationships and the number of merchants or businesses willing to pay for access and enhanced features.

Most conventional loyalty programs for customers are predicated on enhancing value for the merchants or businesses, or those companies affiliated with those merchants or businesses. However, with unique, ever-changing and timely offers from merchants and businesses, customer usage will increase, which will in turn, increase the value to not only the primary merchants or businesses, but those companies affiliated with the merchants or businesses. The relationship can thus be viewed as symbiotic amongst all of the parties.

In accordance with the general teachings of the present invention, a consumer marketing system is provided, comprising: (1) a primary business operating an online website, the website being selectively accessible by the primary business's customers; and (2) a marketing system incorporated into a section of the website offering goods or services to the customers, wherein the goods or services are provided by a secondary business affiliated with the primary business.

The customers may have to provide a password (and possibly a user name) to access the website, as well as providing a possibly different password (and possibly a different user name) to access the marketing system. The customers can selectively employ a search function of the marketing system to identify individual offers of goods or services provided by the secondary business. Alternatively, the secondary business can proactively present individual offers to the customers based on any one of the following factors: demographic, socioeconomic, website browsing history, product or service preferences, and/or purchasing habits. Additionally, the secondary business can proactively present individual coupon or certificate offers to the customers based on any one of the following factors: demographic, socioeconomic, website browsing history, product or service preferences, and/or purchasing habits. Also, the secondary business can proactively present potential savings data to the customers based on the customer's viewing or selection of an individual offer. Furthermore, the secondary business can proactively present individual contest offers to the customers, as well as proactively present feedback requests or survey requests to the customers. In addition, the secondary business can proactively present e-mail reminders to the customers presenting individual offers from the secondary business. Moreover, the secondary business can modify the offering of the goods or services to the customers on a real time basis, as well as dynamically modify the offering of the goods or services to the customers. The secondary business may have to provide a password to access or modify the marketing system.

Further areas of applicability of the present invention will become apparent from the detailed description provided hereinafter. It should be understood that the detailed description and specific examples, while indicating the preferred embodiment of the invention, are intended for purposed of illustration only and are not intended to limit the scope of the invention.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 is a screen capture of a customer homepage, in accordance with the general teachings of the present invention;

FIG. 2 is a screen capture of a customer search results page, in accordance with the general teachings of the present invention;

FIG. 3 is a screen capture of a customer deal details page, in accordance with the general teachings of the present invention;

FIG. 4 is a screen capture of a coupon popup page, in accordance with the general teachings of the present invention;

FIG. 5 is a screen capture of a survey popup page, in accordance with the general teachings of the present invention;

FIG. 6 is a screen capture of a recommended deals and prize contest portions of a customer homepage, in accordance with the general teachings of the present invention;

FIG. 7 is a screen capture of a customer category search results page, in accordance with the general teachings of the present invention;

FIG. 8 is a screen capture of a customer subcategory search results page, in accordance with the general teachings of the present invention;

FIG. 9 is a screen capture of a deal detail section of a customer homepage, in accordance with the general teachings of the present invention;

FIG. 10 is a screen capture of a deal detail section of a customer homepage showing the customer how to redeem the offer, in accordance with the general teachings of the present invention;

FIG. 11 is a screen capture of an alternative customer category search results page, in accordance with the general teachings of the present invention;

FIG. 12 is a screen capture of an alternative coupon popup page, in accordance with the general teachings of the present invention;

FIG. 13 is a screen capture of a prize contest entry page, in accordance with the general teachings of the present invention;

FIG. 14 is a screen capture of a prize description page, in accordance with the general teachings of the present invention;

FIG. 15 is a screen capture of a prize contest official rules page, in accordance with the general teachings of the present invention;

FIG. 16 is a screen capture of a feedback request page, in accordance with the general teachings of the present invention;

FIG. 17 is a screen capture of a drop down menu feature of feedback request page, in accordance with the general teachings of the present invention;

FIG. 18 is a screen capture of a customer preferences page, in accordance with the general teachings of the present invention;

FIG. 19 is a screen capture of a detailed portion of a customer preferences page, in accordance with the general teachings of the present invention;

FIG. 20 is a screen capture of a privacy policy statement page, in accordance with the general teachings of the present invention;

FIG. 21 is a screen capture of a terms of service page, in accordance with the general teachings of the present invention;

FIG. 22 is a screen capture of a secondary business or partner login page, in accordance with the general teachings of the present invention;

FIG. 23 is a screen capture of a secondary business or partner deals page, in accordance with the general teachings of the present invention;

FIG. 24 is a screen capture of a detailed portion of a secondary business or partner deals page, in accordance with the general teachings of the present invention;

FIG. 25 is a screen capture of a secondary business or partner deal location page, in accordance with the general teachings of the present invention;

FIG. 26 is a screen capture of a secondary business or partner deal category page, in accordance with the general teachings of the present invention;

FIG. 26a is a screen capture of a secondary business or partner deal page illustrating the relevancy meter concept of targeting deals to a specific group of customers satisfying certain demographic, socioeconomic, lifestyle, or other factors, in accordance with the general teachings of the present invention;

FIG. 27 is a screen capture of a secondary business or partner administration access page, in accordance with the general teachings of the present invention;

FIG. 28 is a screen capture of a secondary business or partner administration access drop down menu page, in accordance with the general teachings of the present invention;

FIG. 29 is a screen capture of a secondary business or partner deal status page, in accordance with the general teachings of the present invention;

FIG. 30 is a screen capture of a primary business administration access login page, in accordance with the general teachings of the present invention;

FIG. 31 is a screen capture of a primary business administration access menu page, in accordance with the general teachings of the present invention;

FIG. 32 is a screen capture of a primary business administration access drop down menu page, in accordance with the general teachings of the present invention;

FIG. 33 is a screen capture of a primary business administration search results page, in accordance with the general teachings of the present invention;

FIG. 34 is a screen capture of a primary business administration access coupon page, in accordance with the general teachings of the present invention;

FIG. 35 is a screen capture of a primary business administration access deal approval page, in accordance with the general teachings of the present invention; and

FIG. 36 is a screen capture of a primary business administration access customer accounts page, in accordance with the general teachings of the present invention.

The same reference numerals refer to the same parts throughout the various Figures.

### DETAILED DESCRIPTION OF THE INVENTION

The following description of the preferred embodiment(s) is merely exemplary in nature and is in no way intended to limit the invention, or uses.

Enhanced Customer Experience

From a customer's perspective, one of the anticipated goals of the present invention is to present customers with dynamic, timely and relevant offers for products and services from the merchant or business, as well as a great and increasing number of the merchant's or business's partners. The “offers,” “deals,” “specials,” “coupons,” and/or the like will go far beyond the typical “evergreen” offers that the merchant or business's partners currently provide. Although the following description will make primary reference to the partners (e.g., other affiliated merchants and businesses) of the primary merchant or business, it should be appreciated that the present invention can also be practiced by the primary merchant and business.

The merchant's or business's customers and prospective customers will still be able to access a simple list of partners on the public portion of the merchant's or business's website, just like they can do presently. However, in order to access the special promotions and offers from the partners, the merchant's or business's customer should, for example, log into a “Deals” or “Dynamic Deals” section (or other appropriately named section of the website) of the primary merchant's or business's website. This portion of the website can be managed by a third party, but will have the same look and feel as the primary merchant's or business's corporate site. That is, the look and feel of this section of the website will be transparent to customers. With respect to the following description and exemplary figures, a “Deals” or “Dynamic Deals” section has been incorporated into the AAA (i.e., Automobile Club of America) website in order to demonstrate the features of the present invention. However, it should be appreciated that a “Deals” or “Dynamic Deals” section can be incorporated into any merchant's or business's website just as easily.

The Dynamic Deals section of the merchant's or business's website will have the following primary features:

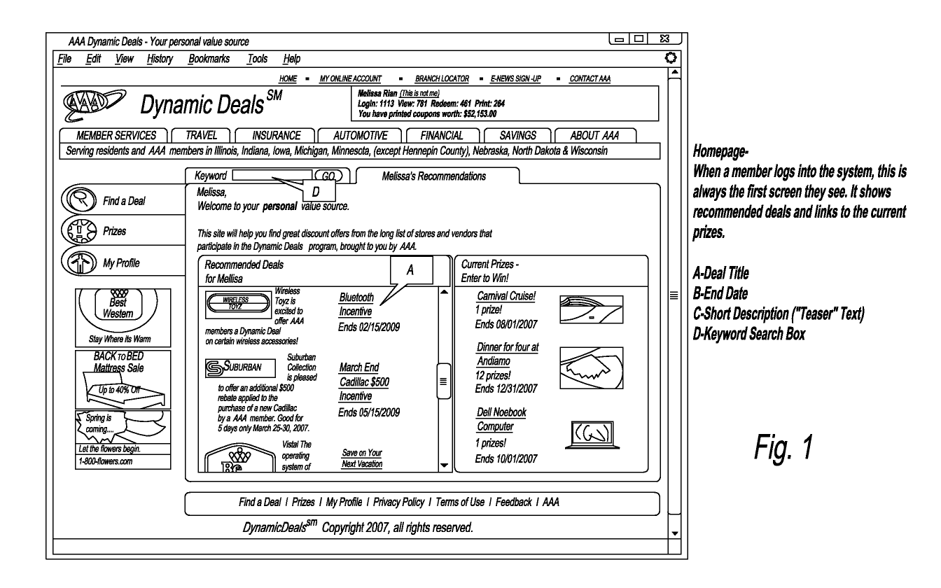

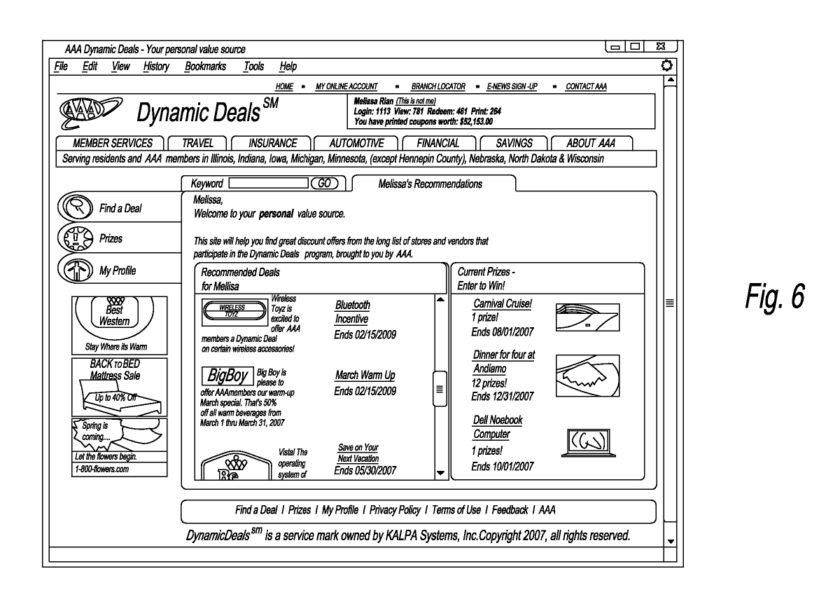

(1) Unique Customer Login: Each customer will have a unique user login and password. This will allow each customer to have customized preferences and account settings and also allows the merchant or business, over time, to build a profile for each of its customers. It also allows the merchant or business to track website usage rates for internal marketing purposes. Referring to FIGS. 1 and 6, there are shown screen captures of a homepage after a customer has logged in to the Dynamic Deals section of the merchant's or business's website.

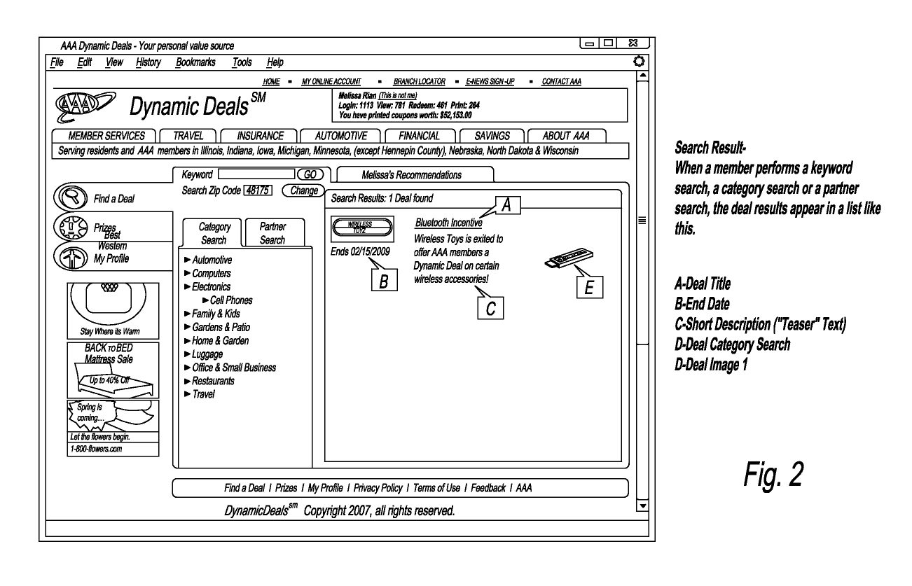

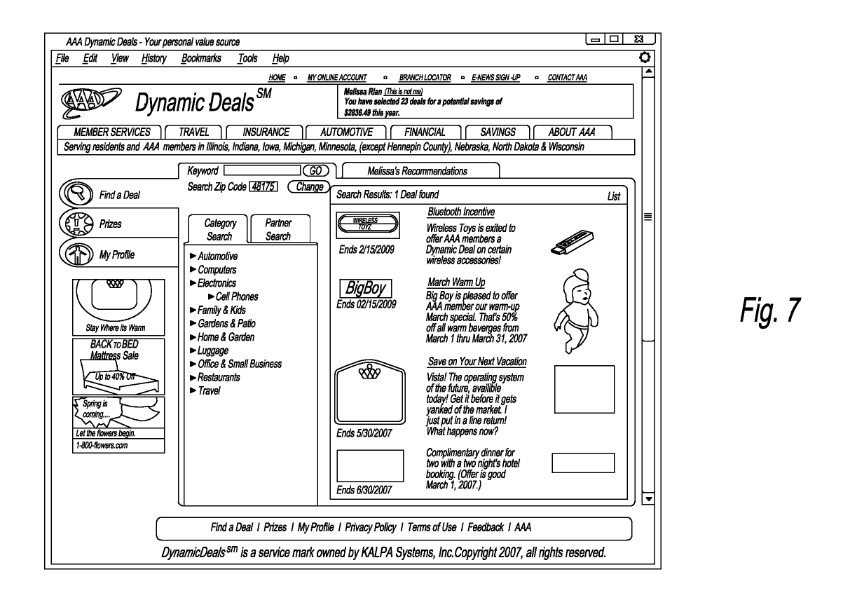

(2) Partners and Deals Search Capabilities: Customers will have the ability to search for partners and special offers through a variety of advanced, but simple, search techniques. Not only will they be able to search for partners geographically, but by category, product, keyword, and/or the like. Referring to FIGS. 2 and 7, there are shown screen captures of a search results page after a customer has entered a search request.

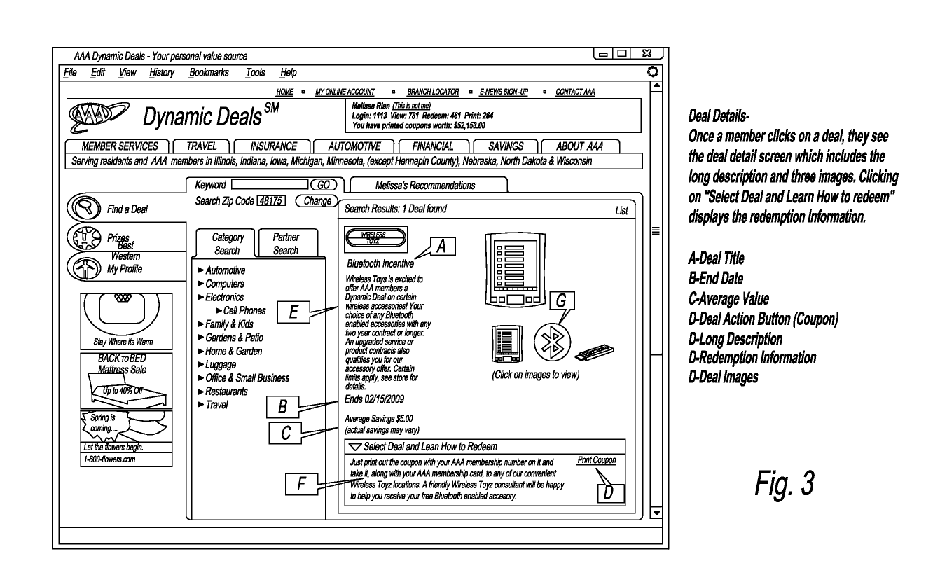

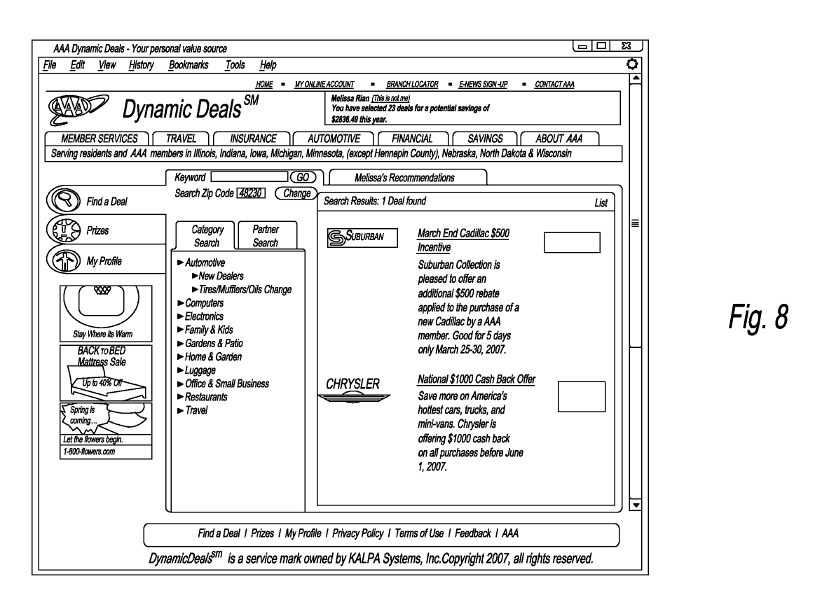

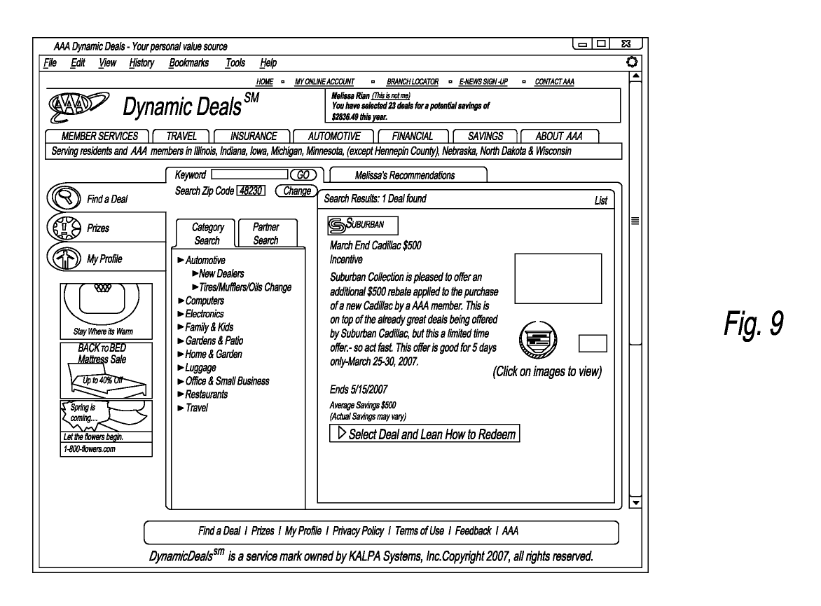

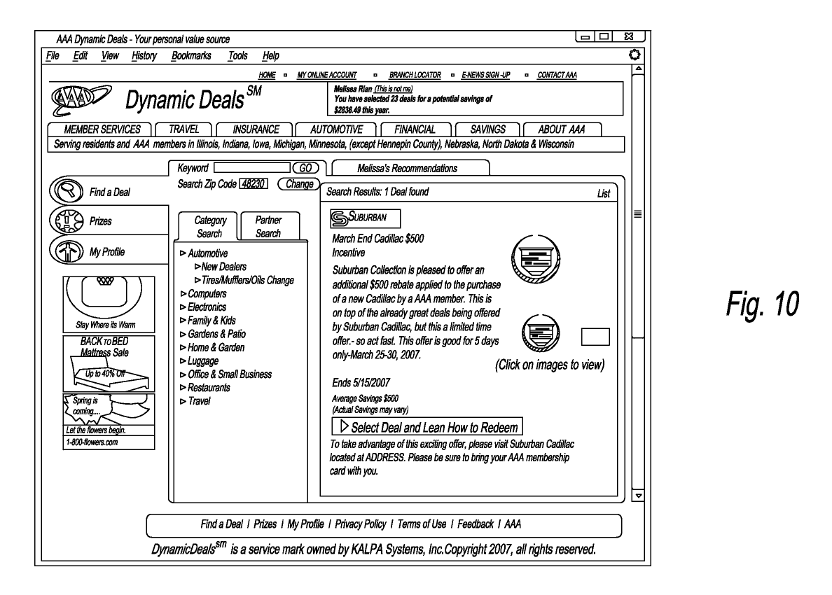

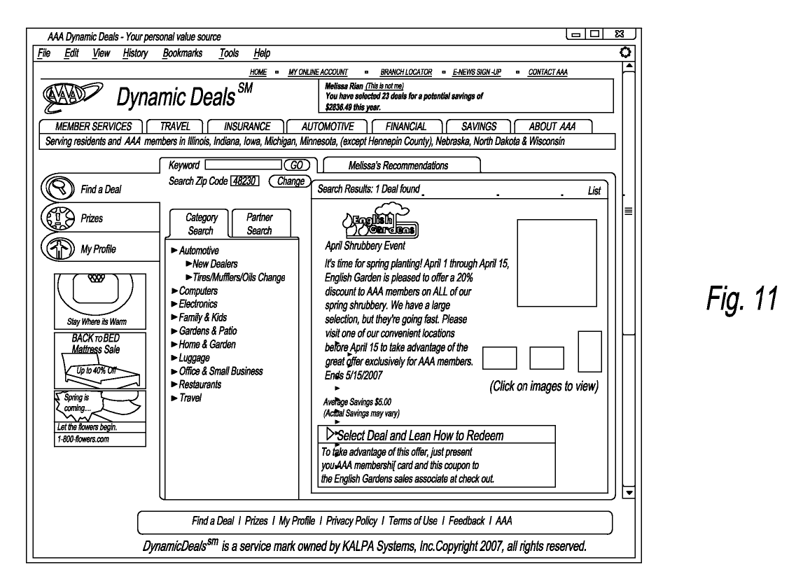

(3) Dynamic Deals: Customers will have the capability to “drill-down” to all of the offers from partners, but the system will also have the ability to present the most relevant offers to the customer first, i.e., increasing the likelihood of a purchase and thereby increasing the value for both the partner and the customer. Dynamic deals are matched to specific customers though a combination of information and data offered by each customer and the specific preferences and marketing parameters attached to each deal by the partners. Referring to FIGS. 3 and 8-11, there are shown screen captures of a deal details page after a customer has expressed interest in a particular offer from a partner. Note how the customer can utilize category/sub-category searching to explore various aspects of partner offers.

(4) Advertising: The system of the present invention is designed to present banner ads and/or the like from certain partners consistent with the most advanced Internet sights, e.g., see the additional partner banner ads in the lower left hand corner of FIGS. 1-11.

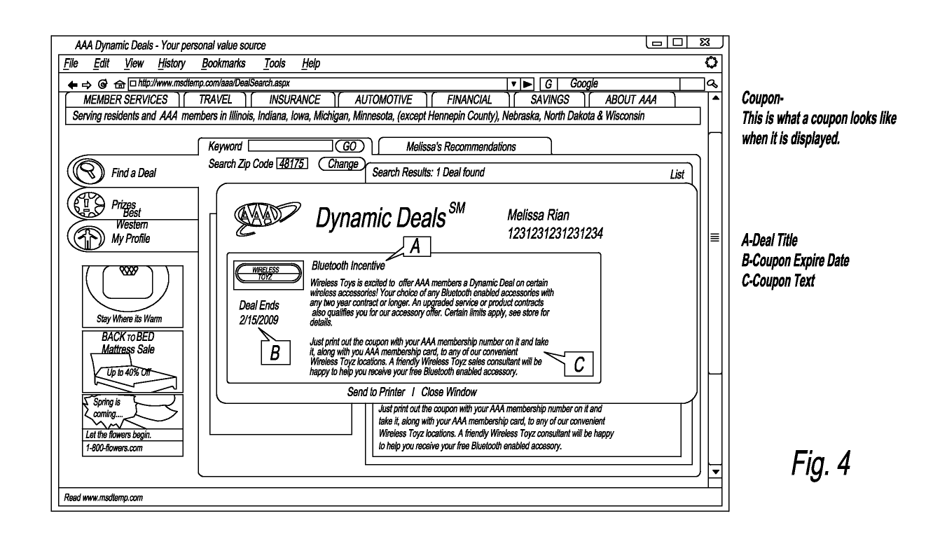

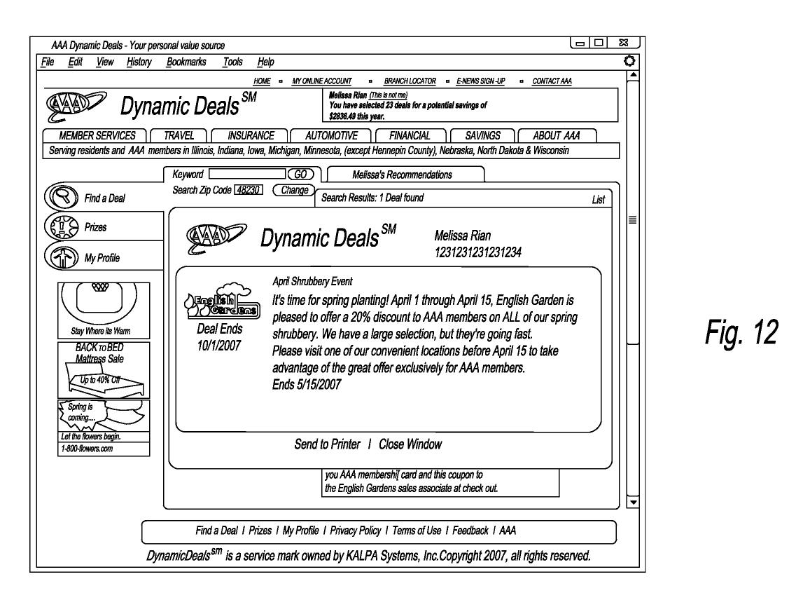

(5) Coupons/Certificates: The system of the present invention will allow customers to print coupons, certificates and/or special offers from partners. This helps customers realize that the special offers are available only to primary merchant's or business's customers, but also helps partners stimulate store traffic and track usage rates. Referring to FIGS. 4 and 12, there are shown screen captures of a coupon “popup” after the customer has expressed interest in a particular offer from a partner.

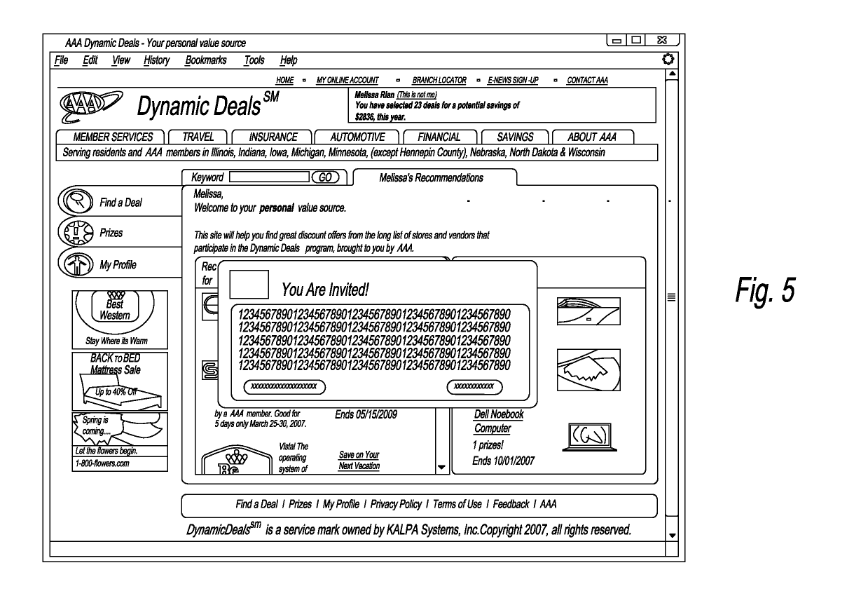

(6) Savings Tracking: The system of the present invention will be able to track, through coupons and certificates printed, as well as other methods, the approximate annual savings a customer achieves through the merchant's or business's loyalty program. Referring to FIGS. 5-12, there are shown screen captures of a tracking feature (e.g., see the upper right hand corner) indicating the customer's potential savings. FIGS. 5-12 also illustrate the primary steps involved in the partner presenting offers to customers, as well as the customers searching for offers from the partners.

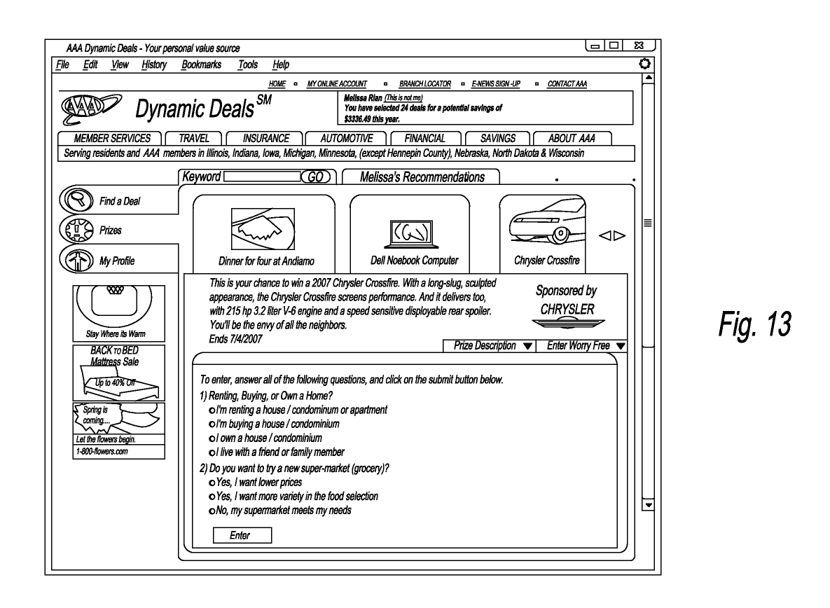

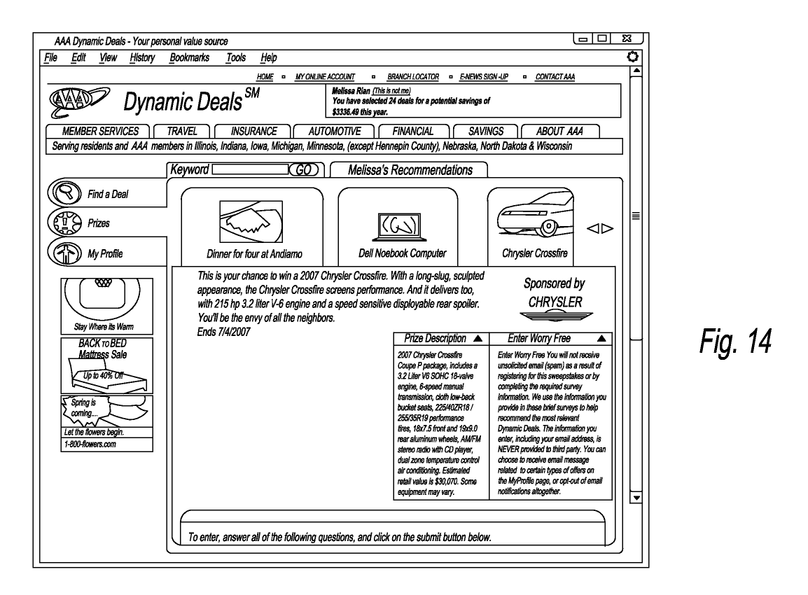

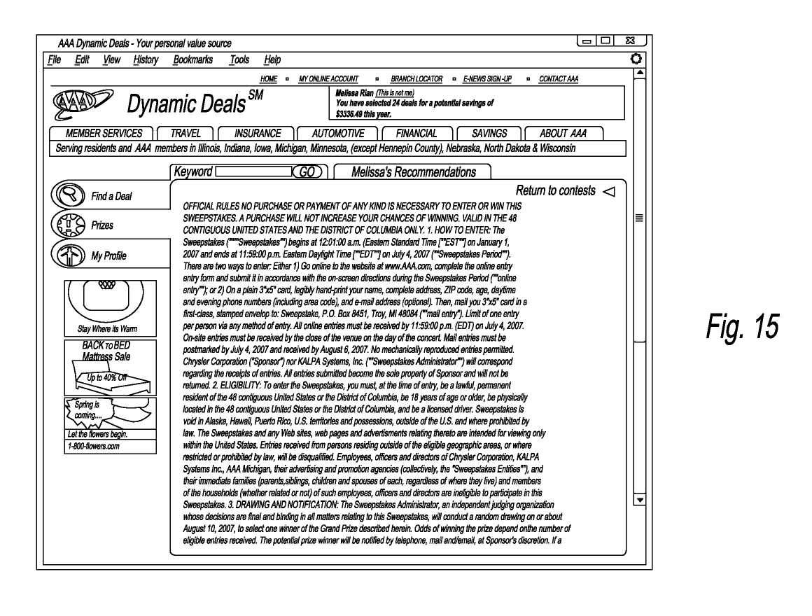

(7) Contests: The system of the present invention will allow customers to sign up for contests and drawings to win prizes from partners. This serves a variety of purposes: (a) it makes the website fun and exciting and draws customer traffic; (b) through brief surveys required to sign up for a contest, it allows the merchant or business to gain more insight into the customers that could be valuable to partners or the merchant's or business's own marketing efforts; and (c) acts as one more way for partners to gain visibility to customers. Referring to FIGS. 13-15, there is shown screen captures of a contest entry form inviting the customer to participate in a survey in order to enter the contest (FIG. 13), a prize description page (FIG. 14), and official contest rules (FIG. 15).

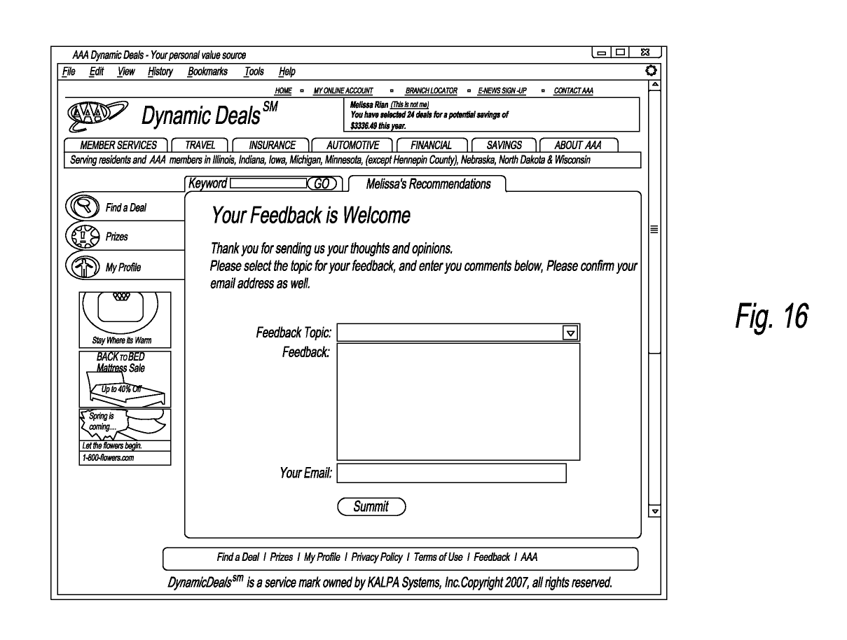

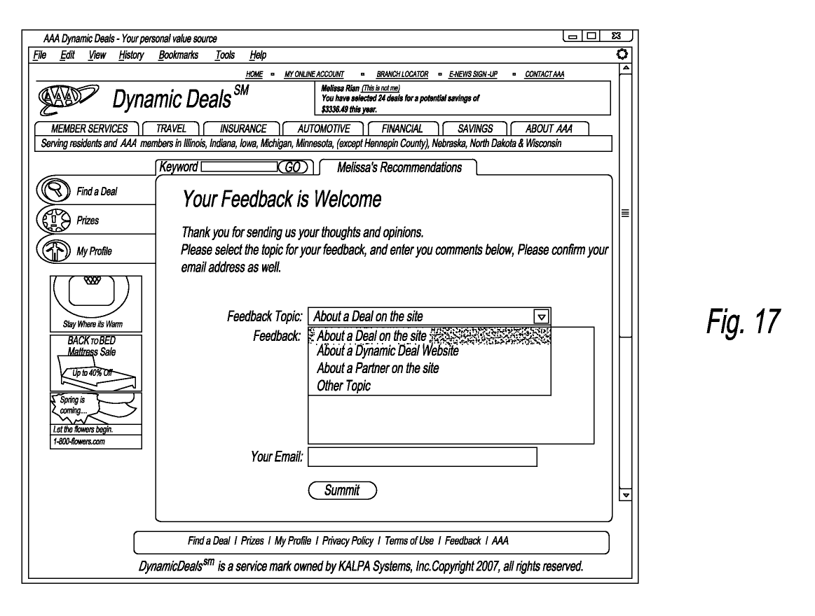

(8) Feedback/Survey: The system of the present invention will allow the merchant or business to post brief online surveys to get customer input and feedback on issues. Referring to FIGS. 16 and 17, there are shown screen captures of a survey popup box inviting the customer to provide feedback.

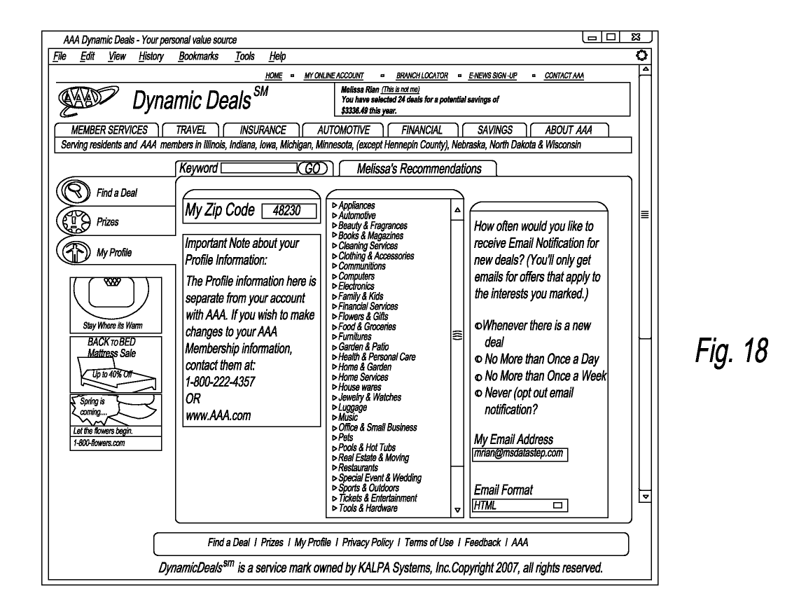

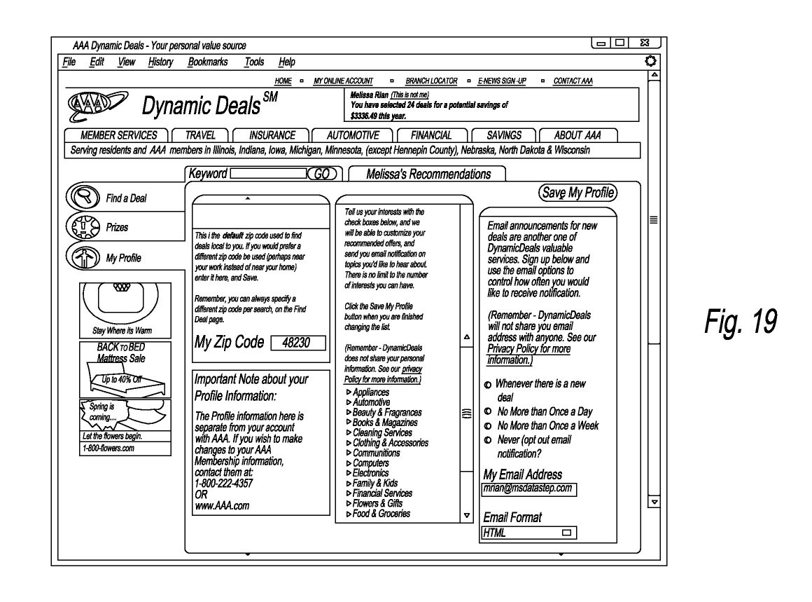

(9) E-mail Reminders (e.g., Permission Marketing): The system of the present invention will allow customers to set up e-mail reminders for certain special offers from partners. It is completely voluntary and customized for each customer's particular needs. Referring to FIGS. 18 and 19, there are shown screen captures of a customer preferences page, allowing the customer to indicate their preferences regarding interests and e-mail preferences.

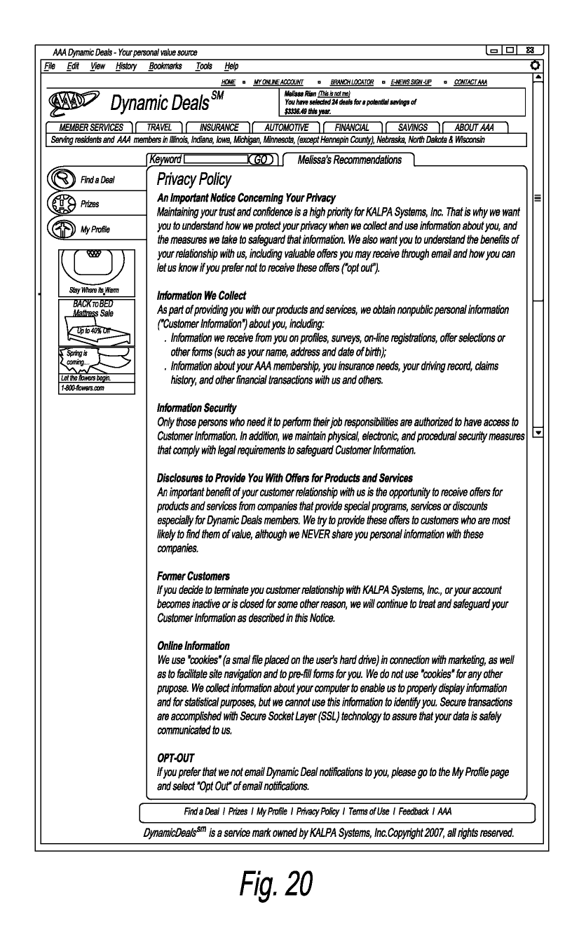

(10) Privacy: While the system of the present invention helps match partner deals to customers and can help gather relevant data on customers to enhance the matching process, individual customer data is never provided to partners or anyone else. The system of the present invention acts as a “nexus” between buyers and sellers, without revealing any personal data. Only the merchant or business, as opposed to the partners, has ownership of individual data. Referring to FIG. 20, there is shown a screen capture of a sample privacy policy.

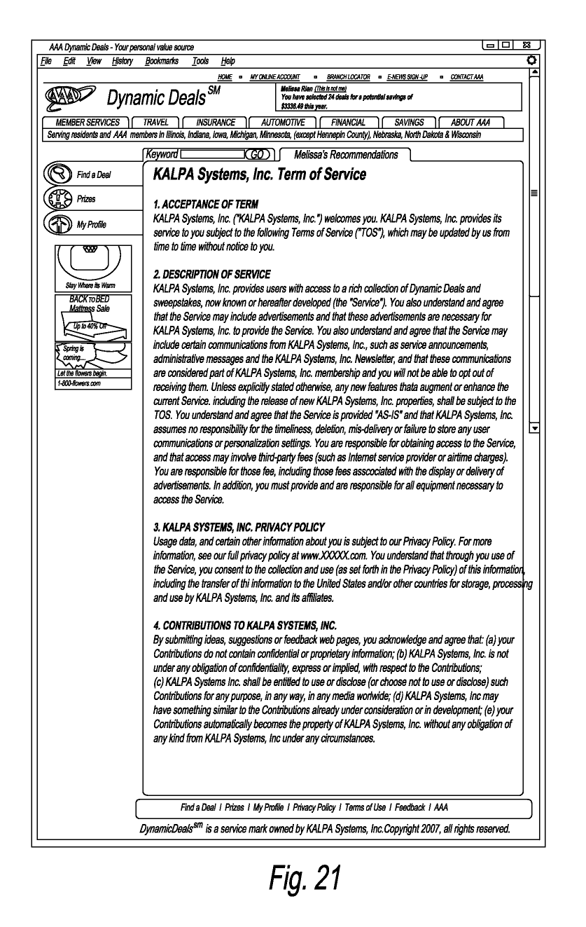

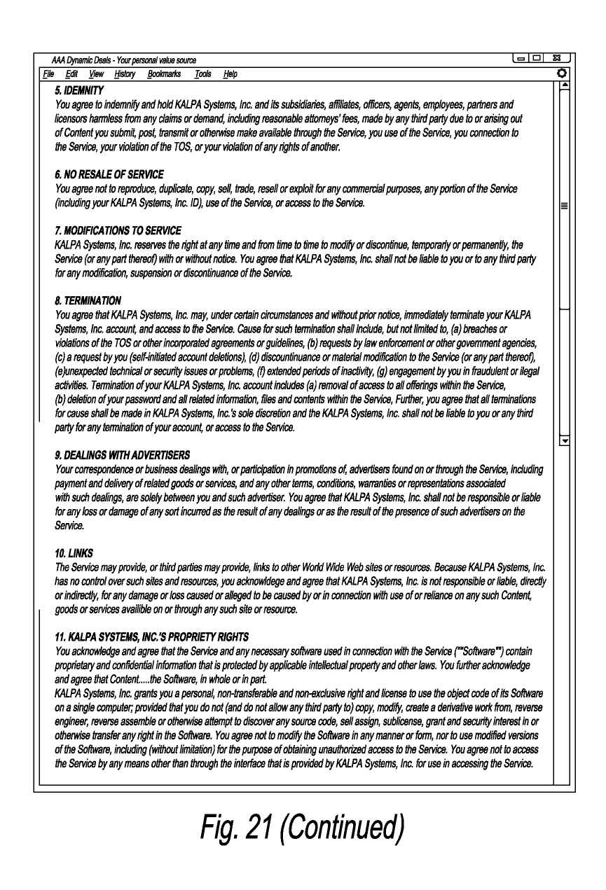

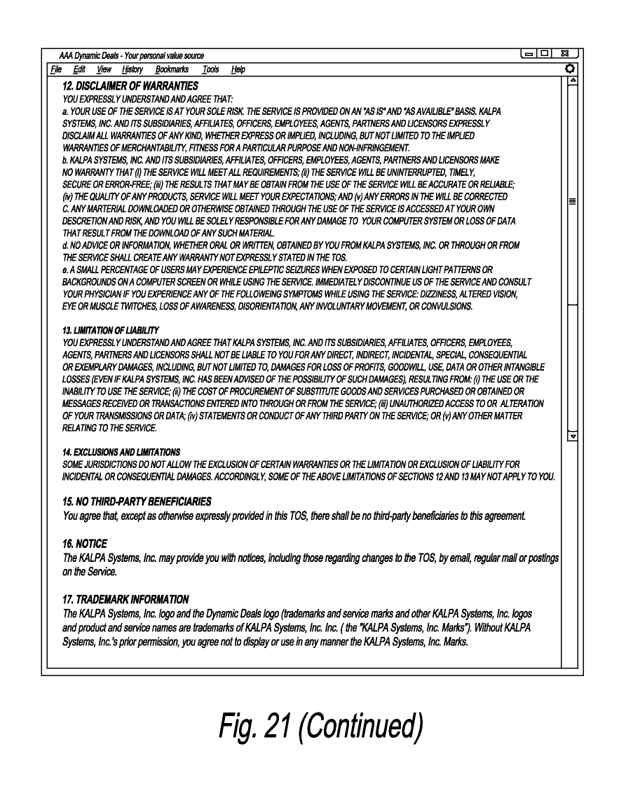

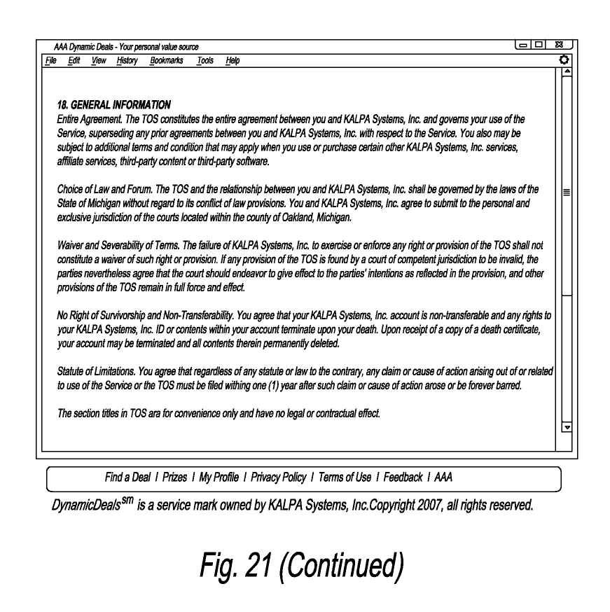

Referring to FIG. 21, there is shown a screen capture of a sample terms of service page in order to make sure that the partner and customer are aware of their respective rights and obligations.

Enhanced Partner Experience

Just as consumers have seemingly endless options on the Internet, businesses do too. Businesses have a plethora of interactive media sites to choose from. This includes literally thousands of electronic newspapers, magazines, specialty sites, search engines, promotional sites, and/or the like. The merchant's or business's loyalty program of the present invention is one alternative in a dynamic, competitive marketplace that is rapidly evolving. The merchant or business is uniquely positioned to offer other companies (i.e., partners) extended marketplace reach and more importantly, the ability to enable these partner companies to extend targeted and highly relevant offers. This proposed enhancement of the loyalty program should provide partners with services and opportunities that are worthy of investment when compared to other marketing alternatives.

From a partner's perspective, one of the anticipated goals of the system of the present invention will be to add value to partners by enhancing their ability to reach the merchant's or business's customers. Over time, partners will have the ability to go beyond the typical “evergreen” offer and target market specific products and services to specific customer profiles. This enhanced program will offer a unique combination of reach and relevance.

The merchant's or business's partners will be able to login into the secure system with their own unique user ID and password. Partners will have the ability to dynamically post and target new offers to the customers. In addition, partners will have direct access to usage data from the website itself. They will be able to see usage rates and page views for their offers, but can also see how frequently their coupons or certificates have been printed. In short, from a single place, partners will be able to post new and relevant offers daily, measure traffic, and in some cases, track the response to these offers, all in real time.

To better organize the website for the participating partner, various input fields have been provided to gather required, as well as optional or recommended, information from the partner to enhance their particular deals or offers to the customers. By way of a non-limiting example, the TABLE below describes various input fields and their characteristics or intended purposes:

TABLE

| Input Field | Need | Description |
|---|---|---|
| Deal Title | Required | The deal title (e.g., limited to |
| | | 50 characters) is displayed to |
| | | customers whenever they find |
| | | the partner's deal and help |
| | | differentiate the partner's deal |
| | | from other offers within the |
| | | same categories. The |
| | | partner's logo can appear next |
| | | to the deal title. The deal title |
| | | can also appear as a hyperlink |
| | | to the partner's deal details. |
| Start Date | Required | The start date is the date the |
| | | partner's deal becomes active. |
| | | When the partner enters a |
| | | deal, it can use the current |
| | | date, and once approved, the |
| | | deal will become active |
| | | immediately. Otherwise, the |
| | | partner can choose a date in |
| | | the future and the deal, once |
| | | approved, will automatically |
| | | activate at midnight on the |
| | | start date. The start date does |
| | | not have to be displayed to the |
| | | customers. |
| End Date | Required | This is the date the partner's |
| | | deal will automatically expire. |
| | | This deactivates the deal and it |
| | | is removed from the customer |
| | | screen within the Dynamic |
| | | Deals Section. The partner |
| | | will receive an automatic e- |
| | | mail notification letting it |
| | | know the deal has expired. |
| | | The deal data will not be |
| | | deleted and will still be |
| | | accessible through the partner |
| | | screens. The end date of the |
| | | offer is displayed wherever the |
| | | offer title or offer details and |
| | | displayed. |
| Coupon Expires | Required | This is the date printed on the |
| | | coupon as the coupon |
| | | expiration date. It is possible |
| | | to set the expiration date on |
| | | the coupon to be later than the |
| | | end date of the deal. This |
| | | way, customers are not |
| | | printing coupons on the |
| | | expiration date. It is |
| | | recommended to make sure |
| | | that the coupon expiration date |
| | | is not earlier than the end date |
| | | of the offer. |
| Deal Tracking Code | Required | The deal tracking code (e.g., |
| | | limited to 10 characters) is an |
| | | internal tracking code that a |
| | | partner can use for tracking |
| | | the deal within the partner's |
| | | organization. It does not have |
| | | to be displayed to the |
| | | customers. |
| Average Value | Required | This is the average savings a |
| | | customer will receive when |
| | | redeeming the offer. This is |
| | | used for purposes of |
| | | calculating the value the |
| | | customers receive from using |
| | | the Dynamic Deals. While |
| | | realizing that it is not always |
| | | possible to put the actual value |
| | | of the deal, particularly for |
| | | deals related to a percentage |
| | | discount, the “average” |
| | | savings a customer is likely to |
| | | receive can be used instead. |
| Deal Action Type | Required | There are three basic types of |
| | | “deal action” which controls |
| | | what redemption action the |
| | | partner would like the |
| | | customer to pursue in order to |
| | | take advantage of the offer: |
| | | (1) coupon - this will display |
| | | a coupon the customer can |
| | | print with specific redemption |
| | | instructions. This can be used |
| | | to drive traffic to a retail |
| | | location; (2) web offer - this |
| | | option allows the partner to |
| | | include a hyperlink to it's |
| | | website to this specific offer |
| | | and include an optional web |
| | | coupon code; and (3) display |
| | | only - this option does not |
| | | display a hyperlink or an |
| | | option to print a coupon. This |
| | | option just displays |
| | | redemption instructions to the |
| | | customer on the screen. |
| Short Description | Required | The short description (e.g., |
| | | limited to 90 characters) is |
| | | also called a “teaser” text and |
| | | is displayed below the deal |
| | | title whenever the partner deal |
| | | is displayed in a list (e.g., |
| | | search results). This should be |
| | | a very brief description of the |
| | | offer and should be used to |
| | | entice the customer to look at |
| | | the deal details. |
| Long Description | Required | The long description (e.g., |
| | | limited to 175 characters) is a |
| | | longer description of the deal |
| | | which is displayed to the |
| | | customer once they select the |
| | | deal. Within the system, a |
| | | counter can be provided on |
| | | how many customers choose |
| | | to look at the details of the |
| | | partner's deal. |
| Redemption | Required | The redemption information |
| Information | | (e.g., limited to 300 |
| | | characters) explains to the |
| | | customers how they can take |
| | | advantage of the partner's |
| | | offer that has been presented |
| | | to them. Customers can click |
| | | a “select deal and learn hop to |
| | | redeem” link in order to see |
| | | this text. Within the system, a |
| | | counter can be provided on |
| | | how many customers choose |
| | | to look at the redemption |
| | | information for the partner's |
| | | deal. |
| Coupon Text | Optional | Coupon text (e.g., limited to |
| | | 300 characters) allows the |
| | | partners to have the option to |
| | | type different text into the |
| | | coupon, or, if they prefer, they |
| | | can automatically use the long |
| | | description and redemption |
| | | information on the coupon. |
| E-mail Text | Required | E-mail text (e.g., limited to |
| | | 300 characters) allows |
| | | customers to receive partner |
| | | offers via e-mail and also |
| | | allows them to specify HTML |
| | | (which includes formatting |
| | | and images) or plain text |
| | | format e-mails. Regardless of |
| | | the format customers choose, |
| | | they will receive the same e- |
| | | mail text from this field. If |
| | | customers receive HTML |
| | | format e-mail, the text will |
| | | include the partner's logo and |
| | | an image of the deal. |
| Coupon Code | Optional | The coupon code (e.g., limited |
| | | to 50 characters) is used with |
| | | web offers. If the partner |
| | | would like the customer to |
| | | enter a specific coupon code |
| | | on their website, the partner |
| | | can put that code in this field. |
| | | The partner could also include |
| | | the code in the redemption |
| | | text and e-mail text fields. |
| Keyword Search | Recommended | The keyword search terms |
| Terms | | (e.g., limited to 50 characters |
| | | each) allows each deal to be |
| | | associated with any number of |
| | | appropriate keywords. For |
| | | instance, for an auto-related |
| | | deal, the partner can include |
| | | various car brand names, car |
| | | types, and/or the like. |
| | | Essentially, any keyword the |
| | | partner would like associated |
| | | with their deal can be |
| | | included, and there is no limit |
| | | to the number of keywords |
| | | they can include. The |
| | | keywords should be relevant |
| | | and appropriate to the offer. |
| | | Using keywords that are not |
| | | appropriate to the partner's |
| | | offer may not be allowed. |
| Categories | Required | Categories are multi-level drill |
| | | downs the customers can use |
| | | to find the partner's deals. At |
| | | least one category per deal is |
| | | required, but multiple |
| | | categories (e.g., as many as |
| | | are appropriate) are allowed. |
| | | The categories should be |
| | | relevant and appropriate to the |
| | | partner's offer. Using |
| | | categories that are not |
| | | appropriate to the partner's |
| | | offer may not be allowed. An |
| | | example of general categories |
| | | that can be used are: |
| | | appliances, automotive, books |
| | | and magazines, cleaning |
| | | services, clothing and |
| | | accessories, communications, |
| | | computers, electronics, family |
| | | and kids, financial services, |
| | | flowers and gifts, food and |
| | | groceries, furniture, garden |
| | | and patio, health and personal |
| | | care, home services, house- |
| | | wares, jewelry and watches, |
| | | luggage, music, office and |
| | | small business, pets, pools and |
| | | hot tubs, real estate and |
| | | moving, restaurants, special |
| | | event and weddings, sports |
| | | and outdoors, tickets and |
| | | entertainment, tools and |
| | | hardware, travel, and/or the |
| | | like. It should be noted that |
| | | sub-categories can also be |
| | | employed. |
| Images | Recommended | Each deal can have at least |
| | | one (e.g., up to three) images |
| | | associated with it, in addition |
| | | to the partner's logo. The |
| | | partner can, e.g., upload either |
| | | .jpg or .gif images and they |
| | | will be dynamically resized on |
| | | the upload, keeping the |
| | | original aspect ratio. For |
| | | example, although the images |
| | | will be fixed-width, the height |
| | | of each image can be flexible. |
| | | Therefore, the partner should |
| | | off load square or tall |
| | | rectangular images, whereas |
| | | wide rectangular images are |
| | | discouraged because they may |
| | | appear quite small on the |
| | | computer screen. |

The “Partner” Section of the merchant's or business's website will have the following features:

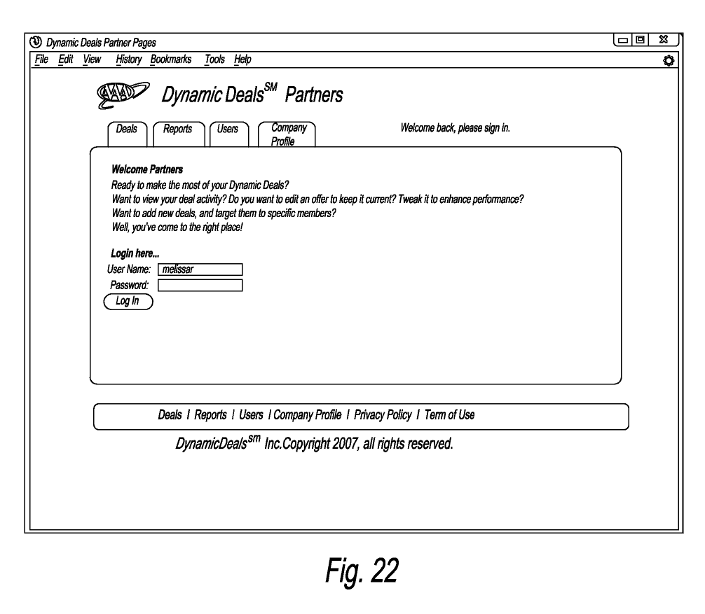

(1) Unique Partner Login: Each partner will have a unique and secure access to the system in order to post offers, access reports, and/or the like. Referring to FIG. 22, there is shown a screen capture of a partner login page inviting the partner to login.

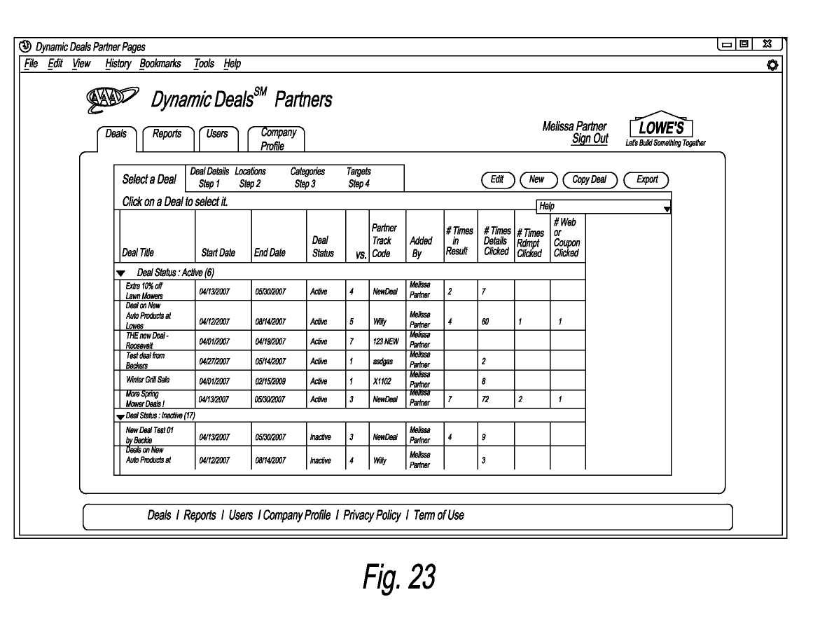

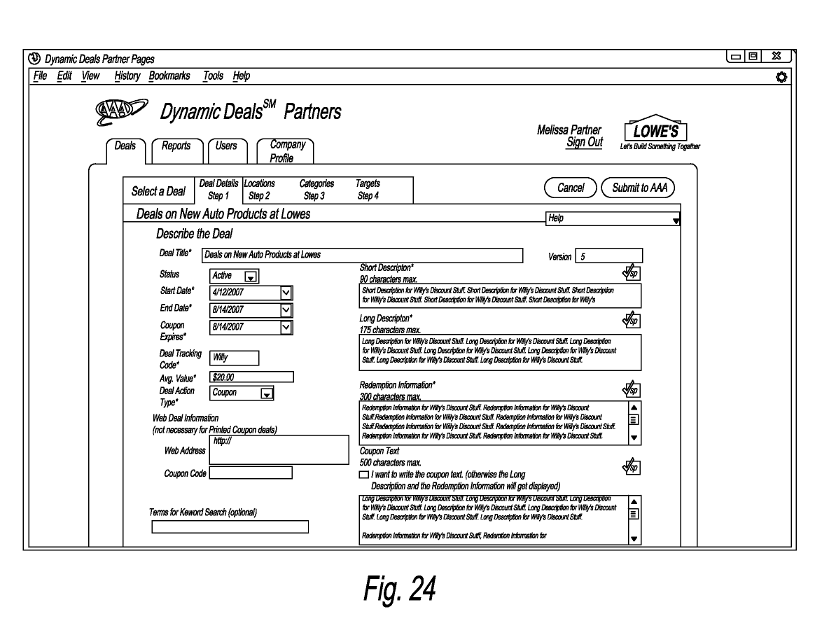

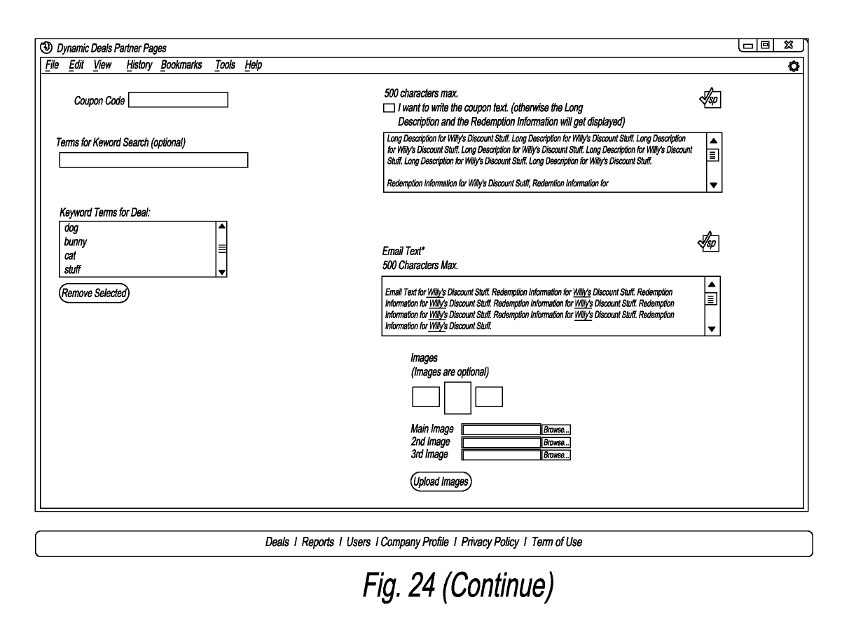

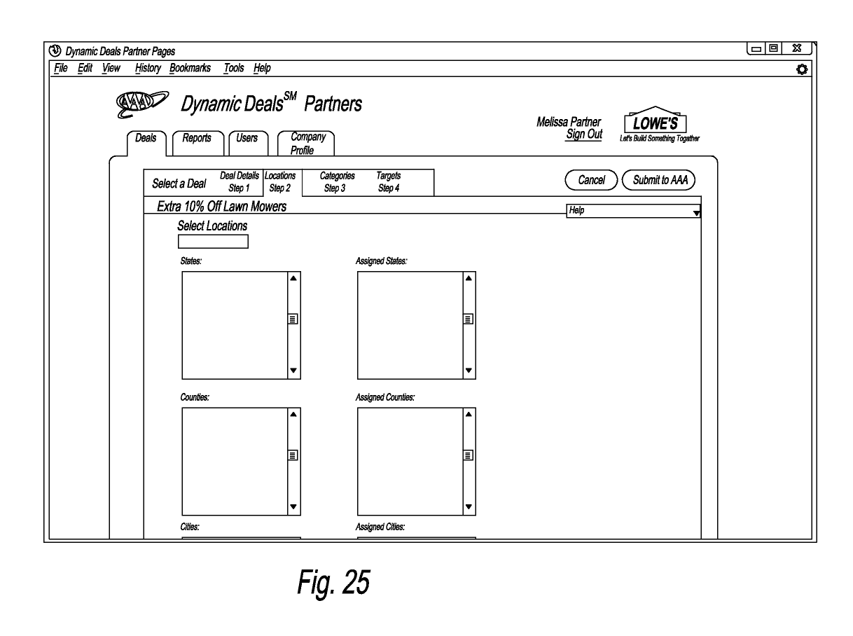

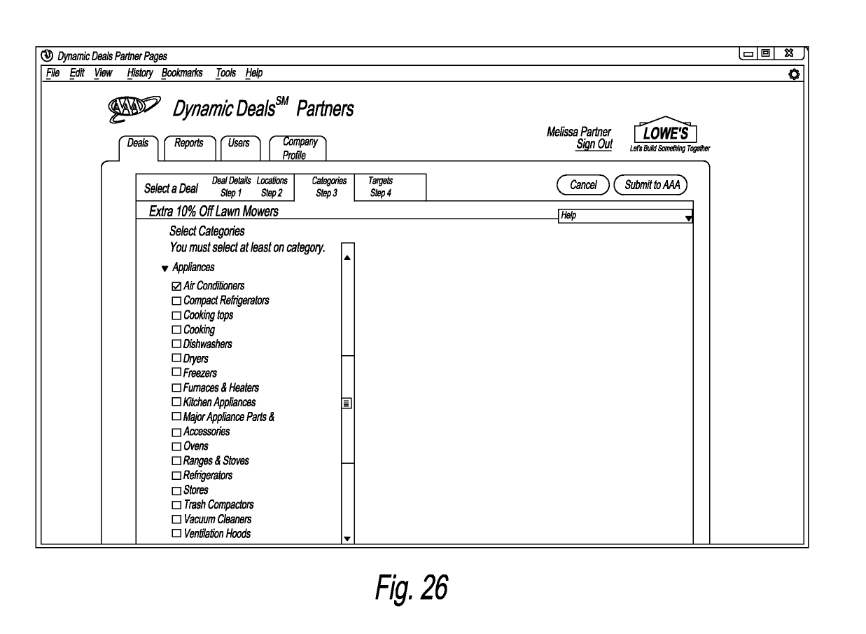

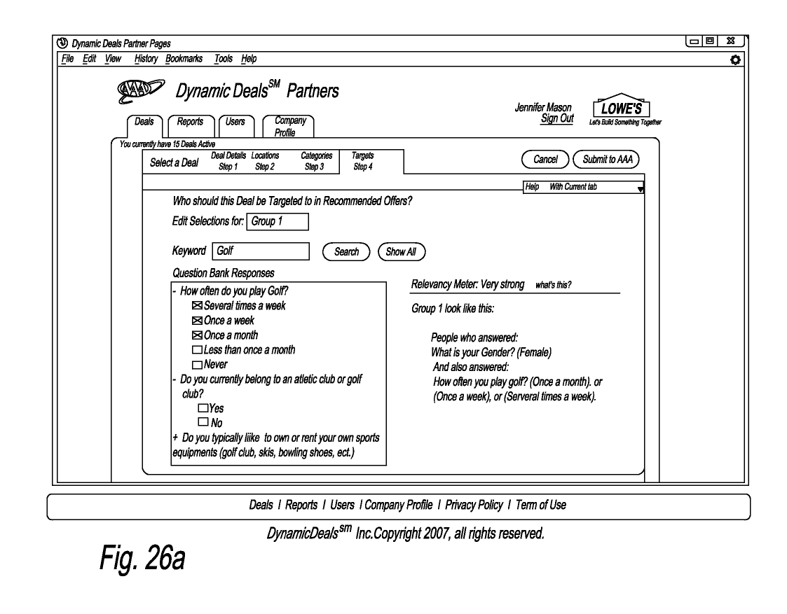

(2) Post New Offers/Edit Existing Offers: Partners will have the ability to add new, or edit existing offers to the system. Partners can customize and target each offer based on multiple criteria. Referring to FIGS. 23-26a, there are shown screen captures of the primary steps in adding new offers, or editing existing offers, to the system, including selecting a deal or offer (presuming that the partner wants to use a pre-existing deal or offer), describing the deal, assigning a geographic location for the deal, and assigning categories/subcategories for the deal. Referring specifically to FIG. 26a, there is shown a screen capture of a partner deal page illustrating the relevancy meter concept of targeting deals to a specific group of customers satisfying certain demographic, socioeconomic, lifestyle, or other factors. In this manner, the partner can specifically target a customer (or potential customer) that is likely to buy their products or services, based in part to pre-existing information about the customer (e.g., data provided by the principal merchant or business) or newly acquired information about the customer (e.g., survey information). For example, a golf club partner can specifically target deals or offers to those customers that have indicated a strong interest in golf, belong to a golf club, or have been known to purchase golf-related goods and services in the past. The “relevancy meter” feature provides the partner with a real time indication of how focused the group is that is being extended the offer (e.g., along a continuum ranging from very weak to very strong). For example, a more focused group (e.g., a relevancy meter of very strong) may represent a relatively low total number of individuals, but at the same time will also represent a group that is very likely to be interested in that particular offer. Thus, the relevancy meter feature of the present invention allows the partner the option of targeting a small, but highly interested group of customers. Conversely, the partner may also decide that the group is “too focused” and can vary the selection criteria to cast a larger net of potential customers (e.g., by also extending the same offer to customers who have only a mild interest in golf). In either scenario, the partner can decide on a real time basis what type of customer is to receive the offer and what the focus strength of that target group looks like.

(3) Reporting Capability: Partners will be able to run reports and will have access to real time statistics from the system. These statistics may include: page views/unique visits to their offers or online partner profile. They will be able to see how often their coupon or certificate has been accessed or printed. They will also be able to give them a count on how often their offer has been presented to customers or e-mailed based on customer priorities.

(4) Potential Advertising Scenarios: Certain partners will have the ability to enhance their image with the merchant's or business's customers though a combination of higher priority listings, more prominent offers, banner advertisements, and/or the like.

(5) Contests: Partners will be encouraged to provide products and services that members can win. Higher cost items may be available for several days or months whereas other lower value products may be offered on a daily or weekly basis. This keeps the website fun and exciting for customers and gives partners one more way of reaching the merchant's or business's customers.

(6) Data Analysis: Ongoing data development and analysis to support both the merchant's and business's marketing initiatives, as well as the partners' unique campaigns.

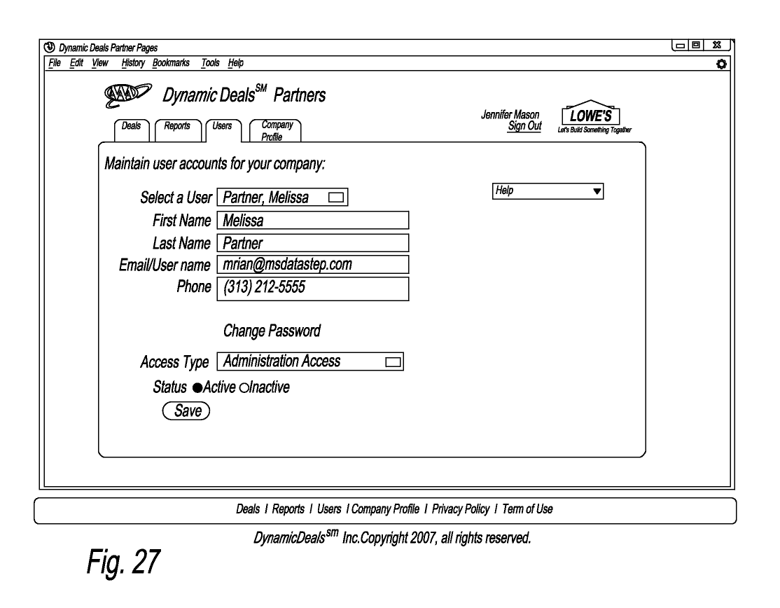

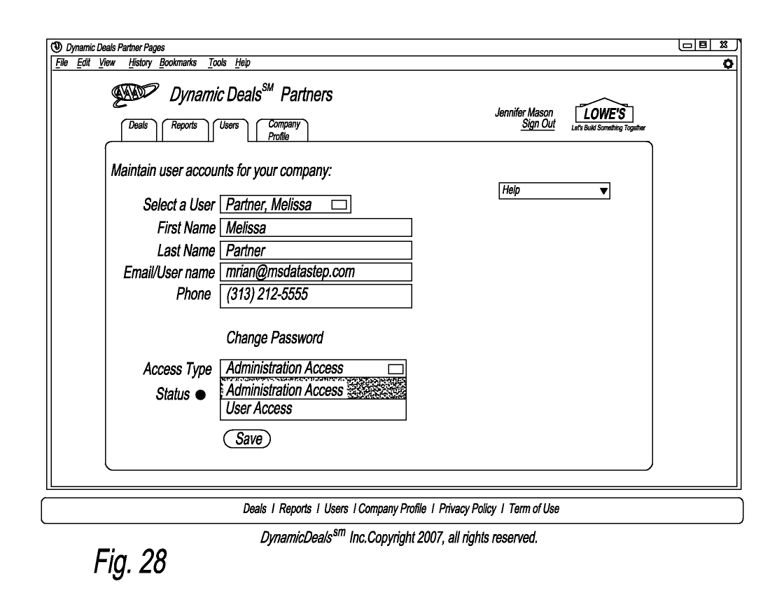

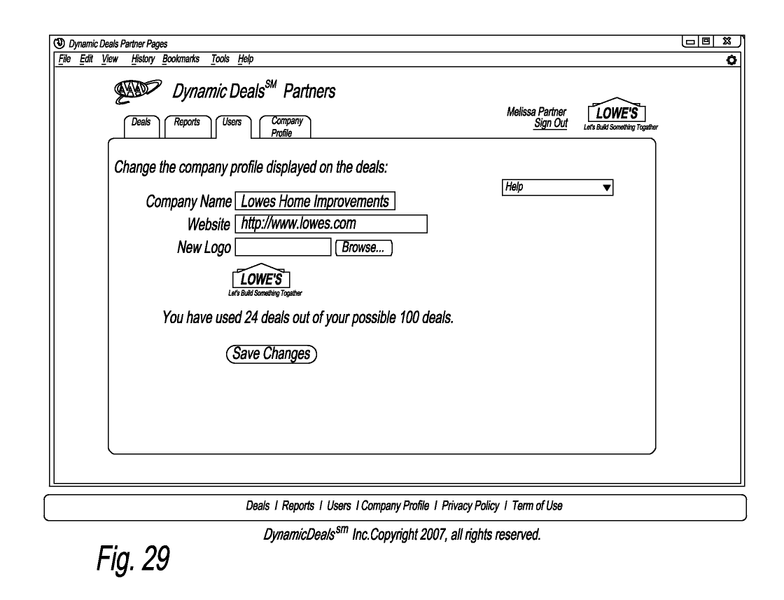

Referring to FIGS. 27-29, there are shown screen captures of an administration access section that allows the partners to review information concerning deal status and/or the like.

Administrative Section

In order to make the system of the present invention as successful as possible, it is important to keep the deals “fresh” and “exciting.” It will be the values that keep the customers coming back, and the more frequently the offers are updated and the more relevant the offers are, the more customer traffic the merchants or businesses will achieve.

The “Administrative” Section of the website will have the following features:

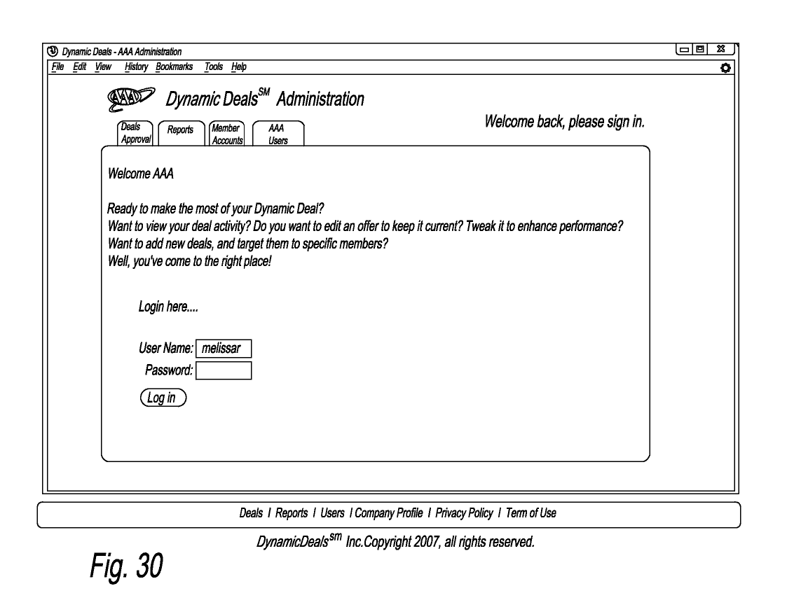

(1) Ability to set-up and maintain member accounts: An electronic data feed, provided on a daily basis, would be used to create, inactivate or edit customer accounts and profiles on the system. However, manual creation or override may be required from time-to-time. Referring to FIG. 30, there is shown a screen capture of a login page for a partner to administer their Dynamic Deals program.

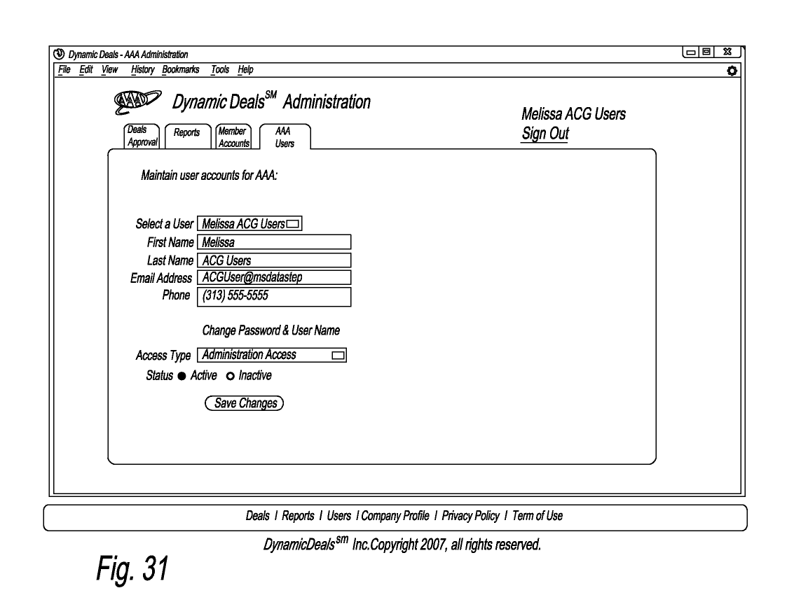

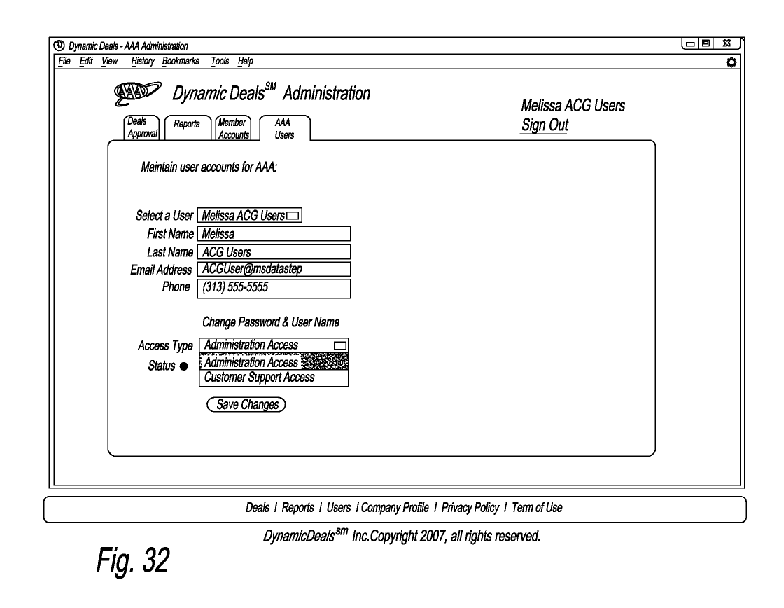

(2) Ability to set-up and maintain partner accounts: As new partners are identified and existing partners choose to use more enhanced services, it will be necessary to create and edit their profiles and provide technical support, as necessary. Referring to FIGS. 31 and 32, there are shown screen captures of partner's pages that a merchant/business (or other partner) can use to add or edit information concerning another partner.

(3) Automatic notification of new offers: The merchant or business will review automatic updates on new offers in order to monitor changing content.

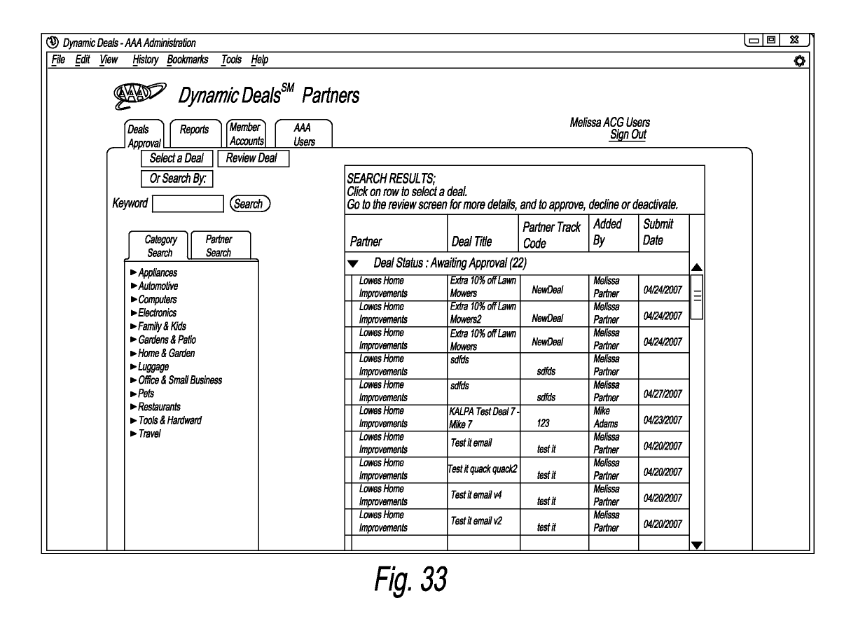

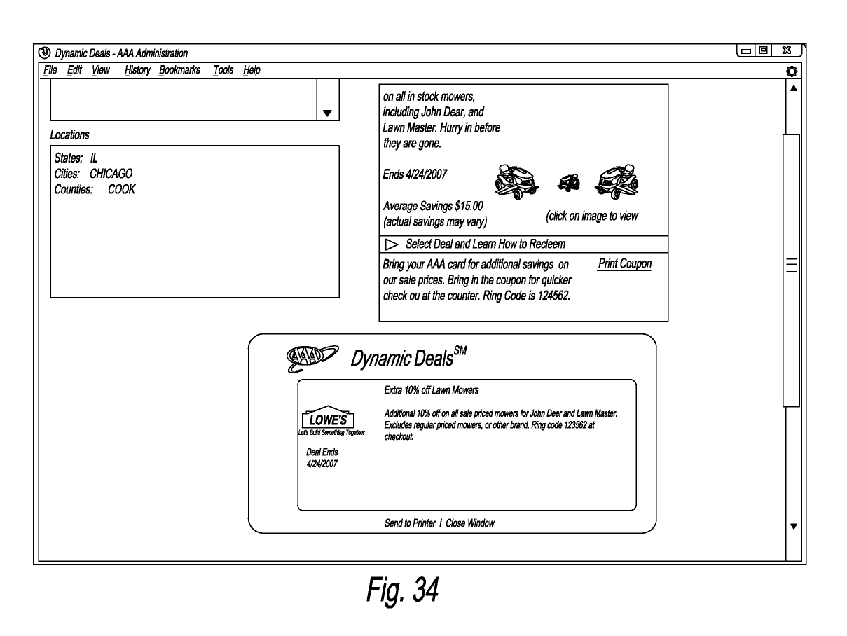

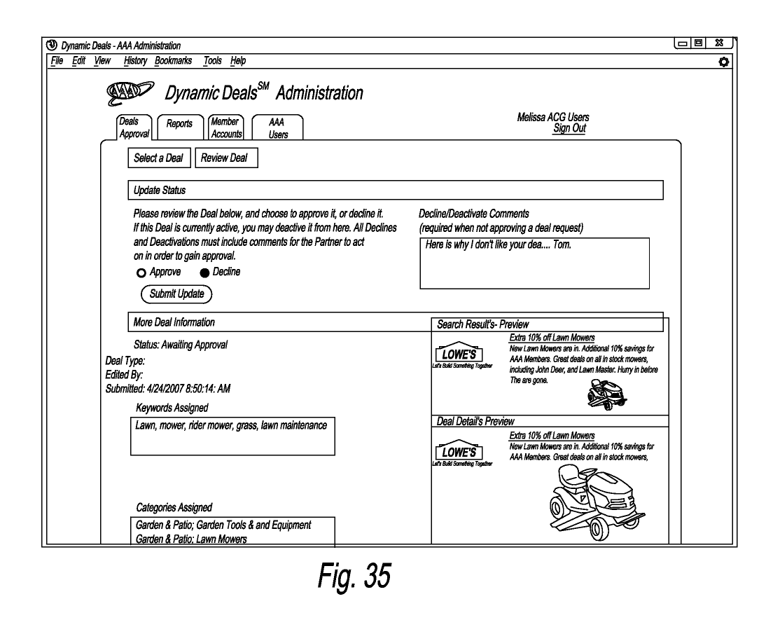

(4) Ability to post and update the merchant's or business's specific offers and advertisements: The merchant or business will want to use the capabilities of the system of the present invention to not only promote partner offers, but to further penetrate their customer base with their offers for their own products and services. Referring to FIGS. 33-35, there are shown screen captures of review deal pages which permit the merchant/business (or other partner) to review proposed partner deals for their customer's consideration.

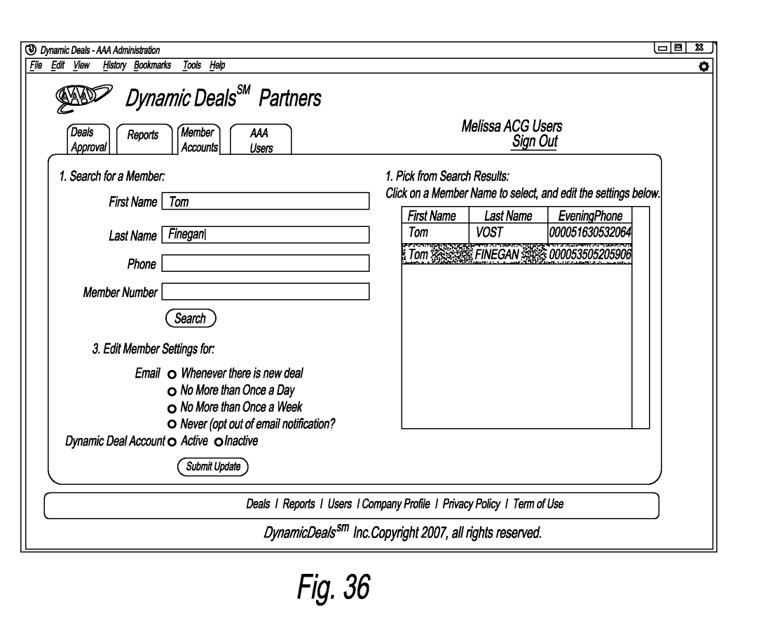

(5) Reporting capabilities: The system of the present invention will offer significant statistical reporting capabilities which allow the merchant or business to gain further insight into their own customers, but will also allow them to show the value of the loyalty program to partners and potential partners. Referring to FIG. 36, there is shown a screen capture of a customer account page that the merchant/business (or other partner) can edit or modify to maximize the ability to reach the customer with new partner deals.

While the invention has been described with reference to an exemplary embodiment, it will be understood by those skilled in the art that various changes can be made and equivalents can be substituted for elements thereof without departing from the scope of the invention. In addition, many modifications can be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A consumer marketing system, comprising:
a primary business operating an online website, the website being selectively accessible by the primary business's customers; and
a marketing system incorporated into a section of the website offering goods or services to the customers, wherein the goods or services are provided by a secondary business affiliated with the primary business.

2. The invention according to claim 1, wherein the customers have to provide a password to access the website.

3. The invention according to claim 1, wherein the customers have to provide a password to access the marketing system.

4. The invention according to claim 1, wherein the customers can selectively employ a search function of the marketing system to identify individual offers of goods or services provided by the secondary business.

5. The invention according to claim 1, wherein the secondary business can proactively present individual offers to the customers based on any one of the following factors: demographic, socioeconomic, website browsing history, product or service preferences, and/or purchasing habits.

6. The invention according to claim 1, wherein the secondary business can proactively present individual coupon or certificate offers to the customers based on any one of the following factors: demographic, socioeconomic, website browsing history, product or service preferences, and/or purchasing habits.

7. The invention according to claim 1, wherein the secondary business can proactively present potential savings data to the customers based on the customer's viewing or selection of an individual offer.

8. The invention according to claim 1, wherein the secondary business can proactively present individual contest offers to the customers.

9. The invention according to claim 1, wherein the secondary business can proactively present feedback requests or survey requests to the customers.

10. The invention according to claim 1, wherein the secondary business can proactively present e-mail reminders to the customers presenting individual offers from the secondary business.

11. The invention according to claim 1, wherein the secondary business can modify the offering of the goods or services to the customers on a real time basis.

12. The invention according to claim 1, wherein the secondary business can dynamically modify the offering of the goods or services to the customers.

13. The invention according to claim 1, wherein the secondary business has to provide a password to access or modify the marketing system.

14. A consumer marketing system, comprising:
a primary business operating an online website, the website being selectively accessible by the primary business's customers; and
a marketing system incorporated into a section of the website offering goods or services to the customers, wherein the goods or services are provided by a secondary business affiliated with the primary business;
wherein the customers have to provide a password to access the marketing system;
wherein the secondary business can proactively present individual offers to the customers based on any one of the following factors: demographic, socioeconomic, website browsing history, product or service preferences, and/or purchasing habits.

15. The invention according to claim 14, wherein the customers have to provide a password to access the website.

16. The invention according to claim 14, wherein the customers can selectively employ a search function of the marketing system to identify individual offers of goods or services provided by the secondary business.

17. The invention according to claim 14, wherein the secondary business can proactively present individual coupon or certificate offers to the customers based on any one of the following factors: demographic, socioeconomic, website browsing history, product or service preferences, and/or purchasing habits.

18. The invention according to claim 14, wherein the secondary business can proactively present potential savings data to the customers based on the customer's viewing or selection of an individual offer.

19. The invention according to claim 14, wherein the secondary business can proactively present individual contest offers to the customers.

20. The invention according to claim 14, wherein the secondary business can proactively present feedback requests or survey requests to the customers.

21. The invention according to claim 14, wherein the secondary business can proactively present e-mail reminders to the customers presenting individual offers from the secondary business.

22. The invention according to claim 14, wherein the secondary business can modify the offering of the goods or services to the customers on a real time basis.

23. The invention according to claim 14, wherein the secondary business can dynamically modify the offering of the goods or services to the customers.

24. The invention according to claim 14, wherein the secondary business has to provide a password to access or modify the marketing system.

25. A consumer marketing system, comprising:
a primary business operating an online website, the website being selectively accessible by the primary business's customers; and
a marketing system incorporated into a section of the website offering goods or services to the customers, wherein the goods or services are provided by a secondary business affiliated with the primary business;
wherein the customers have to provide a password to access the marketing system;
wherein the secondary business can proactively present individual offers to the customers based on any one of the following factors: demographic, socioeconomic, website browsing history, product or service preferences, and/or purchasing habits;
wherein the customers can selectively employ a search function of the marketing system to identify individual offers of goods or services provided by the secondary business;
wherein the secondary business can dynamically modify the offering of the goods or services to the customers on a real time basis.

26. The invention according to claim 25, wherein the customers have to provide a password to access the website.

27. The invention according to claim 25, wherein the secondary business can proactively present individual coupon or certificate offers to the customers based on any one of the following factors: demographic, socioeconomic, website browsing history, product or service preferences, and/or purchasing habits.

28. The invention according to claim 25, wherein the secondary business can proactively present potential savings data to the customers based on the customer's viewing or selection of an individual offer.

29. The invention according to claim 25, wherein the secondary business can proactively present individual contest offers to the customers.

30. The invention according to claim 25, wherein the secondary business can proactively present feedback requests or survey requests to the customers.

31. The invention according to claim 25, wherein the secondary business can proactively present e-mail reminders to the customers presenting individual offers from the secondary business.

32. The invention according to claim 25, wherein the secondary business can modify the offering of the goods or services to the customers on a real time basis.

33. The invention according to claim 25, wherein the secondary business can dynamically modify the offering of the goods or services to the customers.

34. The invention according to claim 25, wherein the secondary business has to provide a password to access or modify the marketing system.
